(19) United States
(12) Patent Application Publication
(10) Pub. No.: US 2024/0270222 A1
(43) Pub. Date: Aug. 15, 2024

(54) BRAKE SYSTEM AND METHOD FOR BRAKING A VEHICLE HAVING AT LEAST TWO AXLES

(71) Applicant: Robert Bosch GmbH, Stuttgart (DE)

(72) Inventor: Dirk Mahnkopf, Eglosheim (DE)

(21) Appl. No.: 18/681,008

(22) PCT Filed: Aug. 9, 2022
(86) PCT No.: PCT/EP2022/072365

§ 371 Date: Feb. 2, 2024

(30) Foreign Application Priority Data
Aug. 17, 2021 (DE) 10 2021 208 993.3

(51) Int. Cl. B60T 13/14; B60T 13/62; B60T 13/74

(52) U.S. Cl. CPC B60T 13/148; B60T 13/142; B60T 13/62; B60T 13/745

(57) ABSTRACT

A brake system for a vehicle having at least two axles. The brake system includes a first axle unit which can be mounted or is mounted on a first axle of the vehicle and has a motorized brake pressure build-up device, a first wheel brake cylinder and a second wheel brake cylinder, and a second axle unit which can be mounted or is mounted on a second axle of the vehicle and is formed separately hydraulically from the first axle unit. The first axle unit includes a first outlet valve assigned to the first wheel brake cylinder and a second outlet valve assigned to the second wheel brake cylinder. The brake fluid can be let out of the first wheel brake cylinder via the first outlet valve and out of the second wheel brake cylinder via the second outlet valve into the connected brake fluid reservoir.

### FIELD

The present invention relates to a brake system for a vehicle having at least two axles. The present invention also relates to a method for braking a vehicle having at least two axles.

### BACKGROUND INFORMATION

In the related art, such as German Patent Application No. DE 10 2016 208 529 A1, brake systems for two-axle vehicles are described, which brake systems have exactly two brake circuits each having two wheel brake cylinders, of which each wheel brake cylinder is hydraulically connected to a master brake cylinder of the relevant brake system.

### SUMMARY

The present invention relates to a brake system for a vehicle having at least two axles, and to a method for braking a vehicle having at least two axles.

The present invention provides brake systems for vehicles having at least two axles, which brake systems have a comparatively compact structure and can be produced at relatively low production costs. As becomes clear from the following description, the conventional hydraulic lines between the at least two axles of the vehicle respectively equipped with the brake system are omitted in a brake system according to the present invention. This results in a saving of a relatively large amount of installation space in the relevant vehicle. In addition, installation of the brake system according to the present invention in the relevant vehicle is thus also facilitated.

A particular advantage of the brake systems created by means of the present invention is the realized design of at least the first axle unit as an open system in such a way that the first axle unit is flushed with the same-aligned brake fluid flows in its first wheel brake cylinder and its second wheel brake cylinder for pressure build-up and pressure reduction. According to an example embodiment of the present invention, the brake fluid flows drawn in by means of the motorized brake pressure build-up device from the connected brake fluid reservoir and subsequently discharged from the first wheel brake cylinder and/or the second wheel brake cylinder into the brake fluid reservoir bring about “thorough” flushing of the first axle unit such that no accumulation of air is possible in the first axle unit. Thus, no functional impairment in a brake system according to the present invention has to be feared due to a collection of air in its first axle unit.

As also becomes clear from the following description, in a brake system according to the present invention, the relevant brake pressure in the wheel brake cylinders of the first axle unit thereof can be adjusted fully automatically/fully autonomously, i.e., without a driver brake force being provided by a driver. This can also be referred to as fully automatic/fully autonomous pressure adjustment.

The first axle unit is preferably a “front axle unit.” In the brake systems according to the present invention, a first brake pressure in the first wheel brake cylinder used as a front-axle wheel brake cylinder and a second brake pressure in the second wheel brake cylinder likewise used as a front-axle wheel brake cylinder can thus be adjusted fully automatically/fully autonomously, i.e., without a driver brake force being provided by a driver of the relevant vehicle. Optionally, however, the first axle unit can also be a “rear axle unit” with the first wheel brake cylinder used as a rear-axle wheel brake cylinder and the second wheel brake cylinder used as a rear-axle wheel brake cylinder. In this case too, the first brake pressure in the first wheel brake cylinder and the second brake pressure in the second wheel brake cylinder can be adjusted fully automatically/fully autonomously.

For example, a brake circuit of the first axle unit can comprise at least the first wheel brake cylinder, the first outlet valve, the second wheel brake cylinder, and the second outlet valve, wherein the motorized brake pressure build-up device is integrated into the brake circuit or is hydraulically connected to the brake circuit. A design of the first axle unit is thus possible as a single-circuit first axle unit.

Alternatively, according to an example embodiment of the present invention, a first brake circuit of the first axle unit can comprise at least the first wheel brake cylinder and the first outlet valve, and a second brake circuit of the first axle unit can comprise at least the second wheel brake cylinder and the second outlet valve, wherein the first brake circuit is hydraulically connected to a first chamber of the motorized brake pressure build-up device designed as a piston-cylinder device, and the second brake circuit is hydraulically connected to a second chamber of the piston-cylinder device. By means of the dual-circuit design of the first axle unit described here, robustness of the first axle unit against leakage occurring at one of the brake circuits thereof is improved. Even if leakage occurs at one of the two brake circuits of the first axle unit during autonomous/automatic driving of the vehicle equipped therewith, the vehicle equipped therewith can at least still be transferred into its safe standstill.

Preferably, according to an example embodiment of the present invention, the first axle unit is designed to be hydraulically separate from the second axle unit in such a way that the first axle unit and the second axle unit are at most connected to one another via at least one signal line and/or bus line. In the embodiment of the brake system described here, the conventional hydraulic lines between the first axle and the second axle of the vehicle equipped with the brake system described here are thus omitted.

As an advantageous development of the present invention, the first axle unit can also additionally comprise a master brake cylinder to which a brake actuating element of the vehicle can be connected or is connected in such a way that at least one piston of the master brake cylinder delimiting at least one chamber of the master brake cylinder can be displaced by means of actuation of the brake actuating element by a driver of the vehicle, wherein the at least one chamber of the master brake cylinder is hydraulically connected to the brake circuit connecting line, to the first brake circuit and/or to the second brake circuit via at least one valveless or valve-equipped connecting line. The driver thus has the possibility of using their driver brake force to directly brake into the wheel brake cylinders of the first axle unit in order to still bring about a buildup of brake pressure in the wheel brake cylinders of the first axle unit in this way. The embodiment of the brake system described here thus also has a mechanical fallback level.

According to an example embodiment of the present invention, the first outlet valve is preferably hydraulically connected to the second outlet valve via a connection section, and the only valve-loaded or valve-equipped connecting line opens out at the connection section, wherein a first check valve arranged in parallel with the first outlet valve is aligned in such a way that a brake fluid transfer in one direction from the first wheel brake cylinder to an outlet of the connecting line at the connection section is prevented by means of the first check valve, and/or a second check valve arranged in parallel with the second outlet valve is aligned such that a brake fluid transfer in one direction from the second wheel brake cylinder to the outlet of the connecting line is prevented by means of the second check valve. Thus, even when the first outlet valve and/or the second outlet valve is closed in the mechanical fallback level, brake fluid can be transferred from the master brake cylinder via the first check valve and/or the second check valve into the at least one associated downstream wheel brake cylinder of the first axle unit.

In a further advantageous embodiment of the brake system of the present invention, the motorized brake pressure build-up device is a piston-cylinder device with at least one chamber and the master brake cylinder is hydraulically connected to at least one chamber and the master brake cylinder is hydraulically connected to the piston-cylinder device via the at least one valveless or valve-equipped connecting line in such a way that the at least one connecting line has a connecting line orifice at the at least one chamber of the piston-cylinder device, wherein the at least one connecting line orifice is designed such that, if at least one displaceable piston of the piston-cylinder device is in its corresponding initial position, brake fluid can be transferred from the master brake cylinder via the at least one connecting line and its corresponding connecting line orifice into the at least one chamber of the piston-cylinder device, while if the at least one displaceable piston is displaced from its corresponding initial position, a brake fluid transfer from the master brake cylinder via the at least one connecting line and its corresponding connecting line orifice into the at least one chamber of the piston-cylinder device is prevented by means of at least one sealing element fastened to the at least one displaceable piston of the piston-cylinder device and/or in the at least one chamber of the piston-cylinder device. During operation of the piston-cylinder device, the master brake cylinder is thus automatically “decoupled” from the piston-cylinder device. Nevertheless, the embodiment described here is automatically transitioned to its fallback level in the event of a failure of the piston-cylinder device, in which the driver, by means of their driver braking force, can brake into the wheel brake cylinders of the first axle unit via the master brake cylinder and the piston-cylinder device. A switching of a valve is thus not necessary for transferring the embodiment of the brake system described here into the mechanical fallback level.

As an additional advantageous development of the present invention, the first wheel brake cylinder can be hydraulically connected via a first isolating valve, and/or the second wheel brake cylinder can be hydraulically connected via a second isolating valve, to the motorized brake pressure build-up device. This enables wheel-specific pressure adjustment in both wheel brake cylinders of the first axle unit. This can also be described as wheel-specific, fully automatic/fully autonomous pressure adjustment in the wheel brake cylinders of the first axle unit of the brake system according to the present invention described here. However, it is pointed out that switching of the first isolating valve and/or of the second isolating valve for the wheel-specific, fully automatic/fully autonomous pressure adjustment in the wheel brake cylinders is generally only necessary for modulation, such as ESP or ABS control. Valve switching noises therefore occur relatively rarely during operation of the brake system according to the present invention described here. This is therefore also referred to as a good NVH (noise, vibration, and harshness) characteristic of the brake system according to the present invention described here.

As a further advantageous development of the present invention, a third check valve arranged in parallel with the first isolating valve can be aligned in such a way that a brake fluid transfer in one direction from the first wheel brake cylinder to the motorized brake pressure build-up device is prevented by means of the third check valve. Alternatively or additionally, a fourth check valve arranged in parallel with the second isolating valve can also be aligned in such a way that a brake fluid transfer in one direction from the second wheel brake cylinder to the motorized brake pressure build-up device is prevented by means of the fourth check valve. In the embodiment of the brake system described here, in the event that the first/second isolating valve is “stuck” in its closed state, the first/second motorized brake pressure buildup devices can still transfer brake fluid via the third/fourth check valve into the first/second wheel brake cylinder. Additionally equipping the brake system with the third check valve and/or the fourth check valve thus increases a safety standard of the relevant brake system.

The advantages described above are also ensured when a corresponding method for braking a vehicle having at least two axles is performed. It is expressly pointed out that the method for braking a vehicle having at least two axles can be developed according to the embodiments of the brake system explained above.

### BRIEF DESCRIPTION OF THE DRAWINGS

Further features and advantages of the present invention will be explained in the following with reference to the figures.

FIGS. 1 to 13 show schematic partial representations of example embodiments of a brake system according to an example embodiment of the present invention.

FIG. 14 shows a flowchart for explaining an example embodiment of the method for braking a vehicle having at least two axles, according to an example embodiment of the present invention.

### DETAILED DESCRIPTION OF EXAMPLE EMBODIMENTS

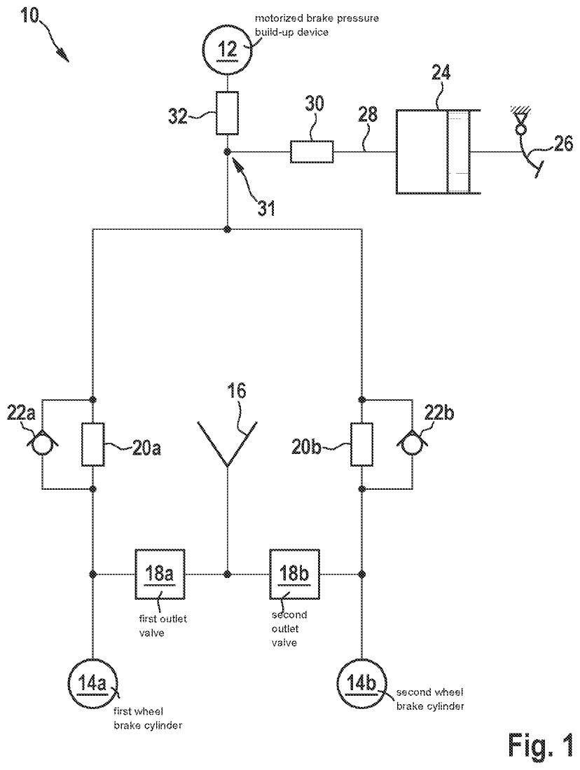

FIG. 1 shows a schematic partial representation of a first embodiment of the brake system.

The brake system shown schematically in FIG. 1 can be installed/is installed in a vehicle/motor vehicle having at least two axles, wherein usability of the brake system is not restricted to any special vehicle type/motor vehicle type of the two-axle vehicle/motor vehicle.

The brake system of FIG. 1 has a first axle unit 10 which can be installed/is installed on a first axle of the vehicle. In addition, the brake system also has at least one second axle unit (not shown in FIG. 1) which can be installed/is installed on a second axle of the vehicle and is designed to be hydraulically separate from the first axle unit 10. The second axle unit is designed in such a way that a first wheel of the second axle and a second wheel of the second axle can be braked/are braked by means of operation of the second axle unit. If the vehicle equipped with the brake system has more than two axles, the brake system can also comprise at least one third axle unit which is designed to be hydraulically separate from the first axle unit 10 and the second axle unit, wherein it is also possible for the at least one third axle unit to be able to be mounted/to be mounted on at least one third axle of the vehicle and to be designed in such a way that a first wheel of at least the one third axle and a second wheel of at least the one third axle can be braked/are braked by means of operation of the at least one third axle unit.

Designing the first axle unit 10 to be hydraulically separate from the second axle unit is understood to mean that no hydraulic line runs between the first axle unit 10 and the second axle unit. In particular, the first axle unit 10 can be designed to be hydraulically separate from the second axle unit in such a way that the first axle unit 10 and the second axle unit are at most connected to one another via at least one signal line and/or bus line. Since the first axle unit 10 is designed to be hydraulically separate from the second axle unit, the conventionally required hydraulic lines between the axles equipped with the wheel brake cylinders are omitted in the brake system of FIG. 1. The brake system thus has a very compact and space-saving structure. In particular, a modular structure of the brake system is realized at comparatively low production costs. The first axle unit 10 and the second axle unit can also be installed as two separate units on the two-axle vehicle equipped therewith. This also facilitates installation of the brake system described here. Correspondingly, designing the at least one third axle unit to be hydraulically separate from the first axle unit 10 and the second axle unit is also understood to mean that no hydraulic line runs between the at least one third axle unit and the first axle unit 10 or the second axle unit.

Preferably, the first axle unit 10 can be installed/is installed as a “front axle unit” on the front axle of the vehicle, while the second axle unit and, where applicable, the at least one third axle unit can be installed/is installed as a “rear axle unit” on the rear axle of the vehicle and/or as a “central axle unit” on at least one axle of the vehicle located between the front axle and the rear axle. In this case, the first axle unit 10 serves to brake the front wheels of the vehicle, while the rear wheels and/or the center wheels of the vehicle can be braked by means of the second axle unit and, where applicable, the at least one third axle unit. Alternatively, however, it is also possible for the first axle unit 10 to be able to be installed/to be installed as a “rear axle unit” on the rear axle of the vehicle or as a “central axle unit” on the at least one axle of the vehicle located between the front axle and the rear axle.

The first axle unit 10 has a motorized brake pressure build-up device 12, a first wheel brake cylinder 14a and a second wheel brake cylinder 14b. The motorized brake pressure build-up device 12 is designed such that brake fluid can be transferred/is transferred from a connected brake fluid reservoir 16 into the first wheel brake cylinder 14a and into the second wheel brake cylinder 14b by means of operation of the motorized brake pressure build-up device 12. In this way, a first brake pressure in the first wheel brake cylinder 14a and a second brake pressure in the second wheel brake cylinder 14b can be increased in such a way that a first wheel of the first axle assigned to the first wheel brake cylinder 14a and a second wheel of the first axle assigned to the second wheel brake cylinder 14b can be braked/are braked. In addition, the first axle unit 10 also comprises a first outlet valve 18a assigned to the first wheel brake cylinder 14a and a second outlet valve 18b assigned to the second wheel brake cylinder 14b. This ensures that in the first axle unit 10 brake fluid can be discharged from the first wheel brake cylinder 14a via the first outlet valve 18a and from the second wheel brake cylinder 14b via the second outlet valve 18b into the connected brake fluid reservoir 16. Preferably, the first outlet valve 18a and the second outlet valve 18b is in each case a normally closed valve.

In the first axle unit 10 of the brake system of FIG. 1, the brake fluid flows suctioned in from the connected brake fluid reservoir 16 by means of the motorized brake pressure build-up device 12 and later discharged from the first wheel brake cylinder 14a and/or the second wheel brake cylinder 14b into the brake fluid reservoir 16 are always aligned in the same direction. For pressure build-up and pressure reduction in its first wheel brake cylinder 14a and its second wheel brake cylinder 14b, the first axle unit 10 is always flushed with brake fluid flows aligned in the same direction. The first axle unit 10 of the brake system in FIG. 1 is therefore an open system. The brake fluid flows oriented in the same direction that occur in the first axle unit 10 also effect a “thorough” flushing of the first axle unit 10, such that no accumulation of air in the first axle unit 10 is possible. This also means that there is no need to fear functional impairments caused by air accumulating in the first axle unit 10 during operation of the brake system of FIG. 1.

Since the brake system described here reliably prevents an accumulation of air at least in its first axle unit 10 by frequently and “thoroughly” flushing the first axle unit 10 with brake fluid flows aligned in the same way, the motorized brake pressure build-up device 12 can be advantageously used to effect a fully automatic/fully autonomous brake pressure build-up in the wheel brake cylinders 14a and 14b of the first axle unit 10. Both the first brake pressure in the first wheel brake cylinder 16a and the second brake pressure in the second wheel brake cylinder 16b can thus be built up/increased fully automatically/fully autonomously, i.e., without a driver brake force being provided by a driver of the relevant vehicle. The first axle unit 10 is thus particularly well suited for autonomously/automatically braking the vehicle equipped therewith, in particular during fully autonomous/fully automatic driving of the relevant vehicle.

In addition, many “identical” parts, i.e., parts of the same type, can be used for the first axle unit 10. The first axle unit 10 can therefore be produced comparatively cost-effectively and by using brake system components already conventionally used.

The motorized brake pressure build-up device 12 can, for example, be at least one pump. The first axle unit 10 can thus be designed to be relatively cost-effective. However, the design shown in FIG. 1 of the motorized brake pressure build-up device 12 of the first axle unit 10 as the at least one pump is to be interpreted only as an example.

As an advantageous development, in the first axle unit 10, the first wheel brake cylinder 14a is hydraulically connected to the motorized brake pressure build-up device 12 via a first isolation valve 20a. The first wheel brake cylinder 14a is thus capable of being decoupled/is decoupled from the motorized brake pressure build-up device 12 by closing the first isolating valve 20a, while brake fluid is transferable/is transferred into the second wheel brake cylinder 14b by means of the first brake pressure build-up device 12. Alternatively or additionally, the second wheel brake cylinder 14b can also be hydraulically connected to the motorized brake pressure build-up device 12 via a second isolating valve 20b. Where applicable, the second wheel brake cylinder 14b is also capable of being decoupled/is decoupled from the motorized brake pressure build-up device 12 by closing the second isolating valve 20b, while brake fluid can (continue to) be transferable/transferred into the first wheel brake cylinder 14a by means of operation of the motorized brake pressure build-up device 12. By equipping the first axle unit 10 with the first isolating valve 20a and/or the second isolating valve 20b, wheel-specific pressure adjustment in both wheel brake cylinders 14a and 14b of the first axle unit 10 of the brake system can thus be performed. For example, ESP or ABS control is possible as the wheel-specific, fully automatic/fully autonomous pressure adjustment in the wheel brake cylinders 14a and 14b.

Furthermore, in the event of a leak in one of the two wheel brake cylinders 14a and 14b of the first axle unit 10, the relevant wheel brake cylinder 14a or 14b can be decoupled from the motorized brake pressure build-up device 12 by closing the upstream isolating valve 20a or 20b in such a way that a fully automatic/fully autonomous pressure adjustment is still possible in the other of the two wheel brake cylinders 14a and 14b by means of the motorized brake pressure build-up device 12. In the brake system of FIG. 1, a high redundancy of the first axle unit 10 is therefore achieved by few modifications. The at least one isolating valve 20a and 20b of the first axle unit 10 can optionally be a switching valve or a continuously adjustable valve suitable for differential pressure adjustment. Preferably, the at least one isolating valve 20a and 20b is in each case a normally open valve.

Optionally, the first axle unit 10 can also have a first isolating valve check valve 22a which is arranged in parallel with the first isolating valve 20a and is oriented in such a way that a transfer of brake fluid in a direction from the first wheel brake cylinder 14a to the motorized brake pressure build-up device 12 is prevented by means of the first isolating valve check valve 22a. In the event that the first isolating valve 20a is “stuck” in its closed state, the motorized brake pressure build-up devices 12 can thus transfer brake fluid via the first isolating valve check valve 22a into the first wheel brake cylinder 14a. Accordingly, a second isolating valve check valve 22b, which is arranged in parallel with the second isolating valve 20b and is aligned in such a way that a brake fluid transfer in a direction from the second wheel brake cylinder 14b to the motorized brake pressure build-up device 12 by means of the second isolating valve check valve 22b is prevented, can also be advantageous. In this case, the motorized brake pressure build-up devices 12 can still transfer brake fluid into the second wheel brake cylinder 14b via the second isolating valve check valve 22b even when the second isolating valve 20b is “stuck” in its closed state. Additionally equipping the brake system/its first axle unit 10 with the at least one isolating valve check valve 22a and 22b thus increases a safety standard of the relevant brake system.

As a further advantageous development, the first axle unit 10 in FIG. 1 additionally comprises a master brake cylinder 24 to which a brake actuating element 26 of the vehicle can be connected/is connected in such a way that at least one piston of the master brake cylinder 24 delimiting at least one chamber of the master brake cylinder 24 can be displaced/is displaced by means of an actuation of the brake actuating element 26 by a driver of the vehicle. The brake actuating element 26 can be a brake pedal, for example. By means of the actuation by the driver of the brake actuating element 26, brake fluid can be transferred from the at least one chamber of the master brake cylinder 24 into the first wheel brake cylinder 14a and/or into the second wheel brake cylinder 14b at least via at least one valveless or valve-equipped connecting line 28. In the brake system of FIG. 1, a mechanical fallback level is thus formed in which, in particular in the event of failure of the motorized brake pressure build-up device 12, the driver can still effect a brake pressure buildup in the wheel brake cylinders 14a and 14b of the first axle unit 10 by applying driver brake force to the brake actuating element 26. Thus, even in the event of failure of the vehicle on-board power supply of the vehicle, the driver can still reliably bring the vehicle to a standstill by means of the increase in brake pressure brought about in the wheel brake cylinders 14a and 14b of the first axle unit 10.

At least one master brake cylinder decoupling valve 30 can be inserted in the at least one connecting line 28. During operation of the motorized brake pressure build-up device 12, the master brake cylinder 24 can thus be decoupled from the motorized brake pressure build-up device 12 by closing the at least one master brake cylinder decoupling valve 30 in such a way that the driver brake force applied to the brake actuating element 26 has no influence on the brake pressure present in each of the wheel brake cylinders 14a and 14b. The at least one master brake cylinder decoupling valve 30 can optionally be a switching valve or a continuously adjustable valve suitable for differential pressure adjustment. The at least one master brake cylinder decoupling valve 30 is preferably a normally open valve. Although not shown in FIG. 1, a simulator can also be connected to the master brake cylinder 24 so that the driver actuating the brake actuating element 26 when the at least one master brake cylinder decoupling valve 30 is closed has a standard brake actuation feel/pedal feel.

By way of example only, in the first axle unit 10 of FIG. 1 the single connecting line 28 equipped with the single master brake cylinder decoupling valve 30 has, at an end oriented away from the master brake cylinder 24, an orifice 31 on a line section which forks off from the motorized brake pressure build-up device 12 to the wheel brake cylinders 14a and 14b of the first axle unit 10, or to the at least one isolating valve 20a and 20b arranged upstream of the wheel brake cylinders 14a and 14b of the first axle unit 10. Advantageously, a further decoupling valve 32 can also be arranged between the orifice 31 of the single connecting line 28 on the line section and the motorized brake pressure build-up device 12 such that a brake fluid transfer from the connecting line 28 to the motorized brake pressure build-up device 12 is prevented by closing the decoupling valve 32. In this way, by closing the decoupling valve 32 it can be ensured that the motorized brake pressure build-up device 12 does not act as a “volume sink” during the mechanical fallback mode, impairing the brake pressure increase in the wheel brake cylinders 14a and 14b of the first axle unit 10 caused by the driver's braking force. The decoupling valve 32 is preferably a normally closed valve.

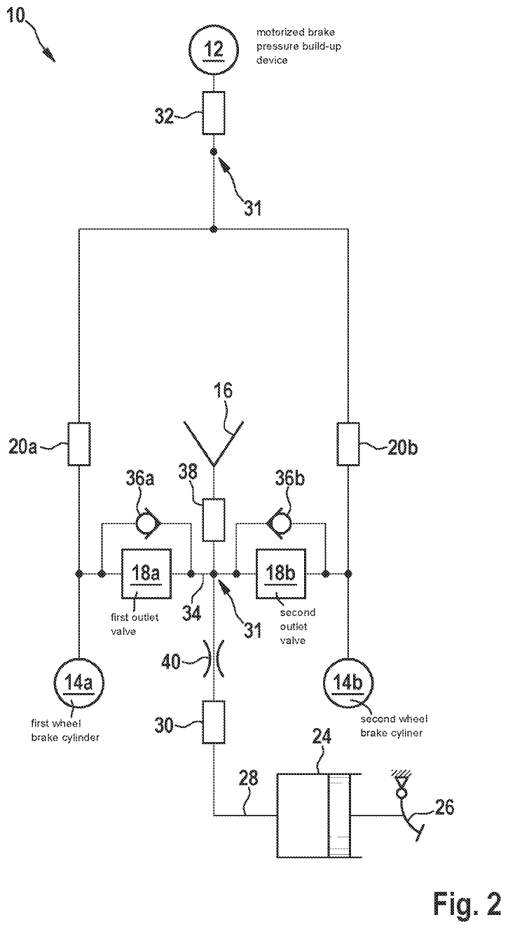

FIG. 2 shows a schematic partial representation of a second embodiment of the brake system.

In the brake system of FIG. 2, the first outlet valve 18a is hydraulically connected to the second outlet valve 18b via a connecting section 34. Preferably, the connecting section 34 is hydraulically connected to the common brake fluid reservoir 16. In contrast to the above-described embodiment, in the first axle unit 10 of FIG. 2 the single valveless or valve-equipped connecting line 28 opens at the connecting section 34. In order to enable a driver actuating the brake actuating element 26 in the mechanical fallback level of the brake system to brake into the first wheel brake cylinder 14a and/or into the second wheel brake cylinder 14b of the first axle unit 10, the first axle unit 10 of FIG. 2 comprises a first check valve 36a arranged in parallel with the first outlet valve 18a and/or a second check valve 36b arranged in parallel with the second outlet valve 18b. The first check valve 36a is aligned in such a way that a brake fluid transfer in a direction from the first wheel brake cylinder 14a to the orifice 31 of the connecting line 28 at the connecting section 34 is prevented by means of the first check valve 36a. Accordingly, for the second check valve 36b an alignment is also preferred in which brake fluid transfer in a direction from the second wheel brake cylinder 14b to the orifice 31 of the connecting line 28 at the connecting section 34 is prevented by means of the second check valve 36b. This means that the driver can still brake at least into one of the wheel brake cylinders 14a and 14b of the first axle unit 10 via the first check valve 36a and/or the second check valve 36b during the mechanical fallback level as well.

In order to prevent the brake pressure increase in the at least one wheel brake cylinder 14a and 14b of the first axle unit 10 thus caused by the driver from being impaired by the brake fluid reservoir 16 acting as a “volume sink,” a reservoir decoupling valve 38 can further be arranged between the connecting section 34 and the brake fluid reservoir 16. The reservoir decoupling valve 38 is preferably a normally closed valve. Optionally, a throttle 40 can also be inserted into the connecting line 28.

With respect to further features and properties of the brake system of FIG. 2 and their advantages, reference is made to the above-explained embodiment of FIG. 1.

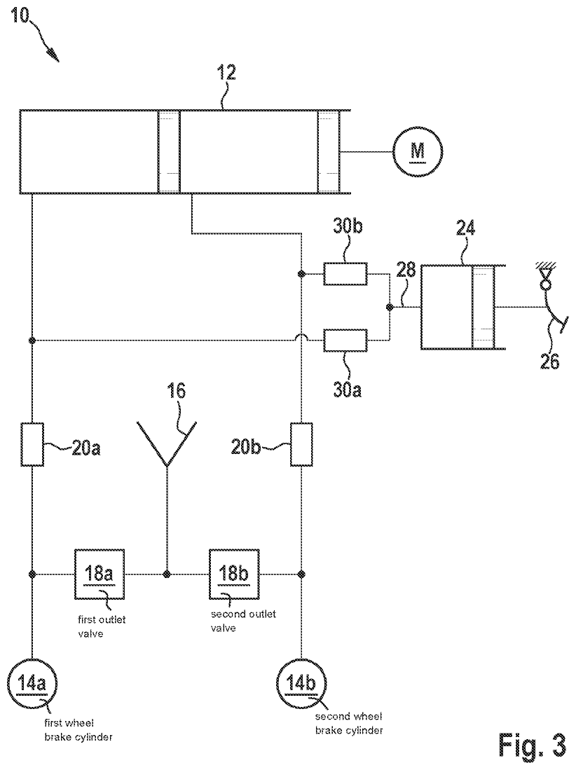

FIG. 3 shows a schematic partial representation of a third embodiment of the brake system.

In contrast to the embodiments described above, the first axle unit 10 of FIG. 3 has a piston-cylinder device 12 with at least one chamber as a motorized brake pressure build-up device 12. Advantageously, the piston-cylinder device 12 of FIG. 3 has a first chamber and a second chamber, wherein the first wheel brake cylinder 14a is connected to the first chamber and the second wheel brake cylinder 14b is connected to the second chamber.

In the braking system shown schematically in FIG. 3, its first axle unit 10 also differs from the embodiment of FIG. 1 in a forking of the single connecting line 28 into two partial lines in such a way that a first partial line of the forked connecting line 28 opens at a line section extending between the first chamber of the piston-cylinder device 12 and the first isolating valve 20a and a second partial line of the forked connecting line 28 opens at a further line section extending between the second chamber of the piston-cylinder device 12 and the second isolating valve 20a. In addition, a first master brake cylinder decoupling valve 30a is arranged in the first partial line of the branched connecting line 28, while a second master brake cylinder decoupling valve 30b is located in the second partial line of the branched connecting line 28.

With respect to further features and properties of the brake system of FIG. 3 and their advantages, reference is made to the above-explained embodiment of FIG. 1.

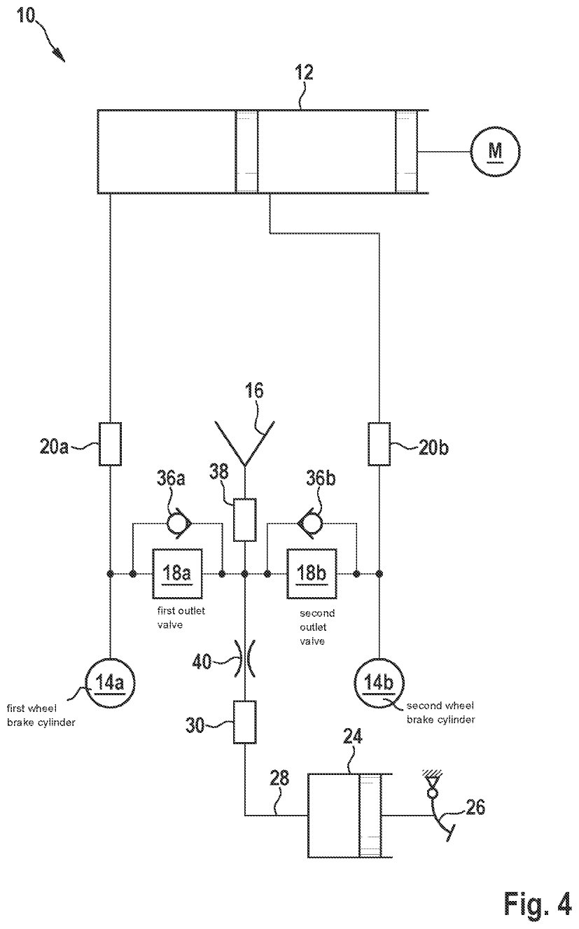

FIG. 4 shows a schematic partial representation of a fourth embodiment of the brake system.

In contrast to the embodiment of FIG. 2, the first axle unit 10 of the brake system of FIG. 4 has the above-described piston-cylinder device 12 with two chambers as the motorized brake pressure build-up device 12, wherein each wheel brake cylinder 14a and 14b of the first axle unit 10 is assigned a different chamber of the piston-cylinder device 12.

With respect to further features and properties of the brake system of FIG. 4 and their advantages, reference is therefore made to the above-explained embodiments of FIGS. 1 to 3.

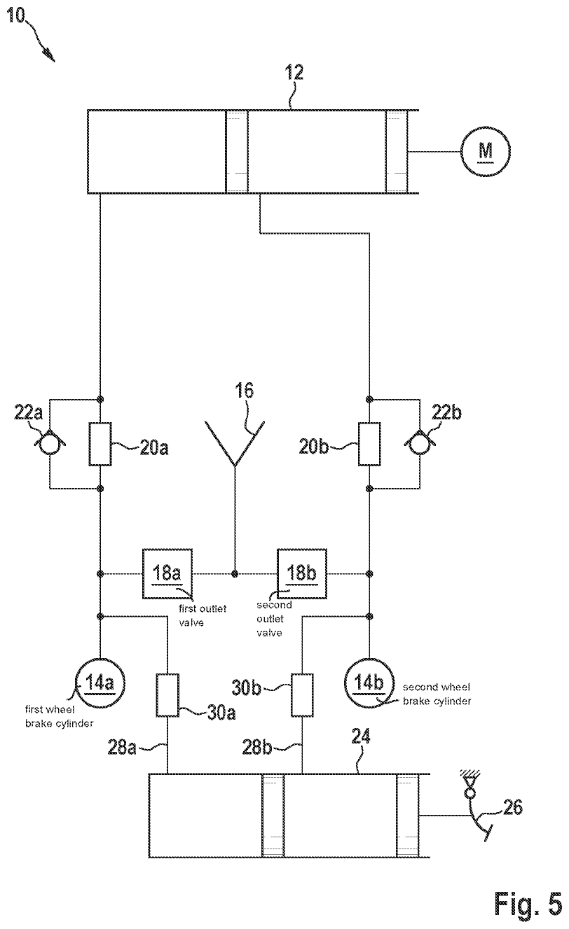

FIG. 5 shows a schematic partial representation of a fifth embodiment of the brake system.

In the brake system of FIG. 5, the master brake cylinder 24 is a tandem master brake cylinder 24. A first chamber of the master brake cylinder 24 is connected to a line section extending between the first wheel brake cylinder 14a and the first isolating valve 20a by means of a first connecting line 28a with the first master brake cylinder decoupling valve 30a. Accordingly, a second chamber of the master brake cylinder 24 is connected to a further line section extending between the second wheel brake cylinder 14b and the second isolating valve 20b by means of a second connecting line 28b with the second master brake cylinder decoupling valve 30b. In this case, the isolating valves 20a and 20b and possibly also the isolating valve check valves 22a and 22b prevent undesired displacement of brake fluid from the master brake cylinder 24 into the chambers of the piston-cylinder device 12 in the mechanical fallback level. The brake fluid displaced from the master brake cylinder 24 by the driver's braking force can thus be used (almost) completely to increase the brake pressure in the wheel brake cylinders 14a and 14b of the first axle unit 10.

With respect to further features and properties of the brake system of FIG. 5 and their advantages, reference is made to the above-explained embodiments of FIGS. 1 to 4.

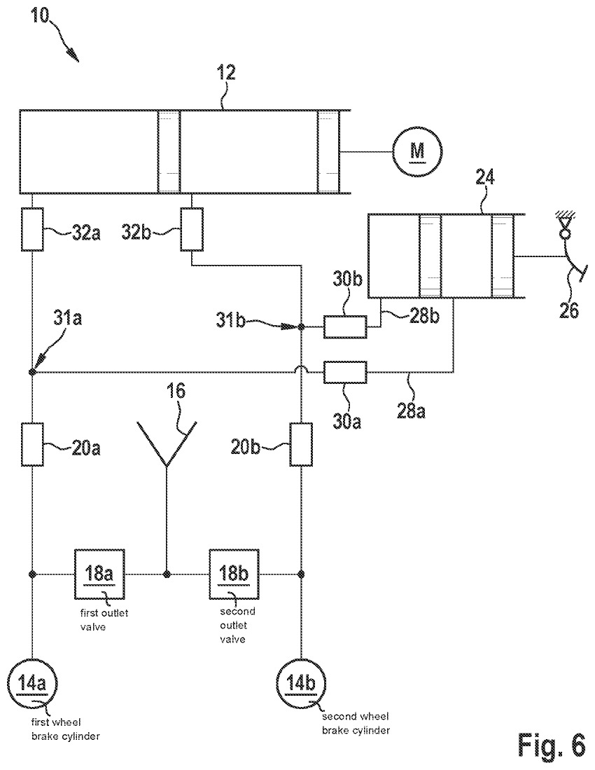

FIG. 6 shows a schematic partial representation of a sixth embodiment of the brake system.

In the brake system of FIG. 6 as well, the master brake cylinder 24 is a tandem master brake cylinder 24. However, a first orifice 31a of the first connecting line 28a directed away from the master cylinder is formed on a line section extending between the first isolating valve 20a and the first chamber of the piston-cylinder device 12, while a second orifice 31b of the second connecting line 28b is located on a further line section extending between the second isolating valve 20b and the second chamber of the piston-cylinder device 12. In order to nevertheless prevent an undesired brake fluid displacement from the master brake cylinder 24 into the chambers of the piston-cylinder device 12 in the mechanical fallback level, the first axle unit 10 also comprises a first decoupling valve 32a arranged between the first orifice 31a of the first connecting line 28a and the first chamber of the piston-cylinder device 12 and a second decoupling valve 32b located between the second orifice 31b of the second connecting line 28b and the second chamber of the piston-cylinder device 12. The decoupling valves 32a and 32b are preferably each a normally closed valve.

With respect to further features and properties of the brake system of FIG. 6 and their advantages, reference is made to the above-explained embodiments of FIGS. 1 to 5.

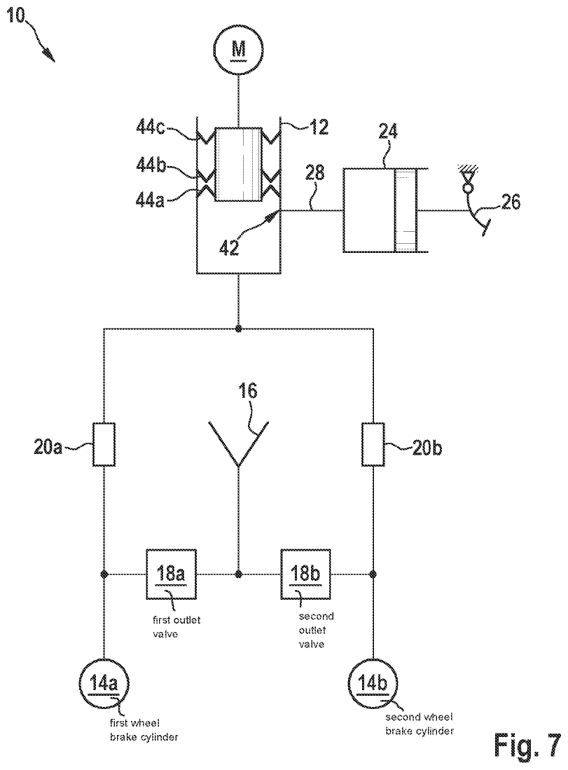

FIG. 7 shows a schematic partial representation of a seventh embodiment of the brake system.

As can be seen in FIG. 7, the master brake cylinder 24 can also be hydraulically connected to the piston-cylinder device 12 via the at least one valveless or valve-equipped connecting line 28 in such a way that the at least one connecting line 28 in each case has a connecting line orifice 42 on the at least one chamber of the piston-cylinder device 12, which orifice is directed away from the master brake cylinder 24. Preferably, moreover, the at least one connecting line orifice 42 is designed such that, if at least one displaceable piston of the piston-cylinder device 12 is in its relevant initial position, brake fluid is transferred from the master brake cylinder 24 via the at least one connecting line 28 and its relevant connecting line orifice 42 into the at least one chamber of the piston-cylinder device 12, while, if the at least one displaceable piston is displaced from its relevant initial position, a brake fluid transfer from the master brake cylinder 24 via the at least one connecting line 28 and its relevant connecting line orifice 42 into the at least one chamber of the piston-cylinder device 12 is prevented by means of at least one sealing element 44a, 44b and 44c attached to the at least one displaceable piston of the piston-cylinder device 12 and/or in the at least one chamber of the piston-cylinder device 12. The advantageous design of the at least one connecting line orifice 42 described here can therefore also be described as a design of the at least one connecting line orifice 42 “as a sniffer bore.”

The at least one advantageous connecting line orifice 42 and the at least one sealing element 44a, 44b, and 44c thus ensure that during operation of the piston-cylinder device 12 in its functional state, the master brake cylinder 24 is “automatically” decoupled from the piston-cylinder device 12, and therefore the driver's braking force applied to the brake actuating element 26 has no influence on the braking pressure in each of the wheel brake cylinders 14a and 14b. In the event of a failure of the piston-cylinder device 12 and/or the vehicle electrical system, the at least one displaceable piston of the piston-cylinder device 12 is generally in its initial position in each case, whereby the brake system is “automatically” transferred to its mechanical fallback level, in which the driver can still, by means of the driver's braking force, reliably increase the brake pressure in the wheel brake cylinders 14a and 14b sufficiently to brake the vehicle. Equipping the brake system of FIG. 7 with a master cylinder decoupling valve 32, 32a, or 32b is therefore superfluous.

In the first axle unit 10 of FIG. 7, the single chamber of the master brake cylinder 24 is connected to the single chamber of the piston-cylinder device 12 via the single connecting line 28. By way of example, the single piston of the piston-cylinder device 12 bears three sealing elements 44a, 44b, and 44c fastened thereto. When the piston of the piston-cylinder device 12 is in its initial position, a first sealing element 44a closest to the connecting line orifice 42 blocks a pressure from the direction of the connecting line orifice 42 and lets through a pressure from the (opposite) direction of the engine. A second sealing element 44b adjacent to the first sealing element 44a lets through a pressure from the direction of the first sealing element 44a and blocks a pressure from the (opposite) direction of the motor. In addition, a third sealing element 44c closest to the engine of the piston-cylinder device 12 lets through a pressure from the direction of the first sealing element 44a and the second sealing element 44b and blocks a pressure from the (opposite) direction of the engine.

With respect to further features and properties of the brake system of FIG. 7 and their advantages, reference is made to the above-explained embodiments of FIGS. 1 to 6.

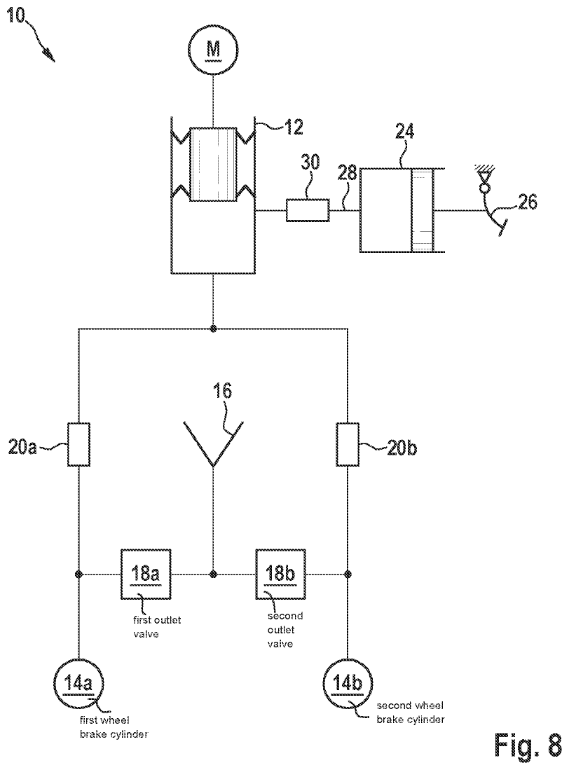

FIG. 8 shows a schematic partial representation of an eighth embodiment of the brake system.

In contrast to the embodiment of FIG. 7, in the first axle unit 10 of FIG. 8 the master brake cylinder decoupling valve 30 is inserted into the single connecting line 28. The formation of the at least one connecting line orifice 42 “as a sniffer bore” and the use of certain types of sealing element can thus be dispensed with in the first axle unit 10 of FIG. 8.

With respect to further features and properties of the brake system of FIG. 8 and their advantages, reference is made to the above-explained embodiments of FIGS. 1 to 7.

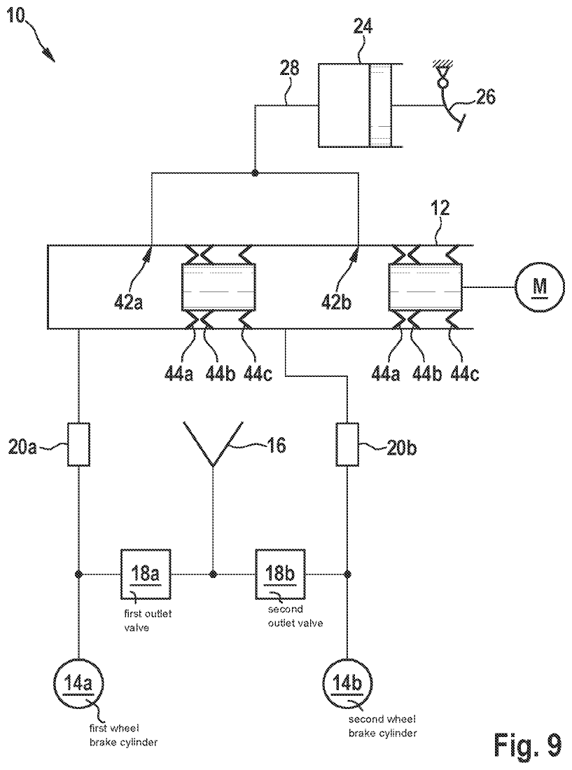

FIG. 9 shows a schematic partial representation of a ninth embodiment of the brake system.

In the brake system shown schematically in FIG. 9, its first axle unit 10 differs from the embodiment of FIG. 7 in the use of the piston-cylinder device 12 with two chambers, wherein each wheel brake cylinder 14a and 14b of the first axle unit 10 is assigned a different chamber of the piston-cylinder device 12, and in the forking of the single connecting line 28 into two partial lines. The first partial line of the forked connecting line 28 has a first connecting line orifice 42a at the first chamber of the piston-cylinder device 12, while the second partial line of the forked connecting line 28 is formed with a second connecting line orifice 42b at the second chamber of the piston-cylinder device 12. Due to the design of each connecting line orifice 42a and 42b “as a sniffer bore,” it is ensured that, if the adjacent piston of the piston-cylinder device 12 is in its relevant initial position, brake fluid can be transferred from the master brake cylinder 24 into the relevant chamber of the piston-cylinder device 12, while when the adjacent piston is displaced from its relevant initial position, the relevant connecting line orifice 42a or 42b is sealed by means of the at least one sealing element 44a, 44b, and 44c. For this purpose, each piston of the piston-cylinder device 12 is equipped with the sealing elements 44a, 44b, and 44c already explained above.

With respect to further features and properties of the brake system of FIG. 9 and their advantages, reference is made to the above-explained embodiments of FIGS. 1 to 7.

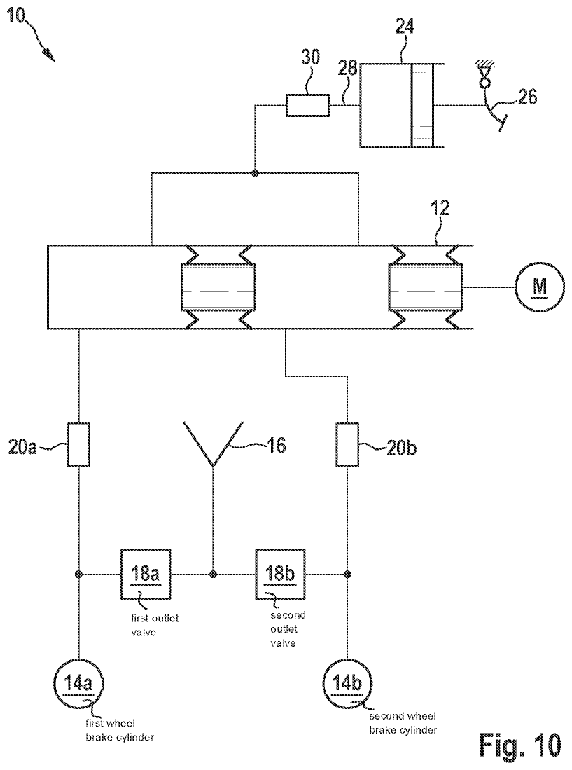

FIG. 10 shows a schematic partial representation of a tenth embodiment of the brake system.

In contrast to the embodiment of FIG. 9, the first axle unit 10 of FIG. 10 has the master brake cylinder decoupling valve 30 in its single connecting line 28. Preferably, the single master brake cylinder decoupling valve 30 is arranged in the connecting line 28 between the master brake cylinder 24 and the fork in the connecting line. The formation of the connecting line orifices 42a and 42b “as sniffer bores” and the use of certain types of sealing elements can therefore be dispensed with in the first axle unit 10 of FIG. 10.

With respect to further features and properties of the brake system of FIG. 10 and their advantages, reference is made to the above-explained embodiments of FIGS. 1 to 9.

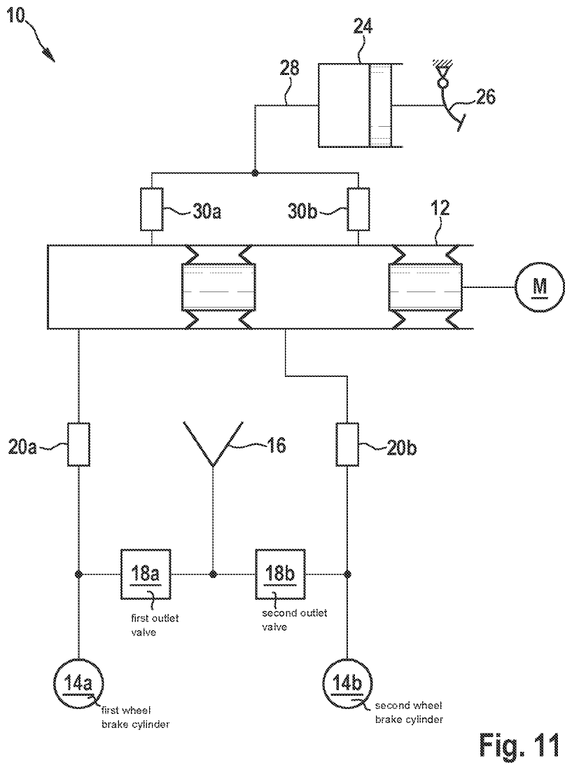

FIG. 11 shows a schematic partial representation of an eleventh embodiment of the brake system.

Instead of the single master brake cylinder decoupling valve 30, the first axle unit 10 of FIG. 11 comprises the first master brake cylinder decoupling valve 30a arranged in the first partial line of the forked connecting line 28 and the second master brake cylinder decoupling valve 30b located in the second partial line of the forked connecting line 28. In the first axle unit 10 of FIG. 10 as well, the formation of the connecting line openings 42a and 42b “as sniffer bores” and the use of particular sealing element types can thus be dispensed with.

With respect to further features and properties of the brake system of FIG. 11 and their advantages, reference is made to the above-explained embodiments of FIGS. 1 to 10.

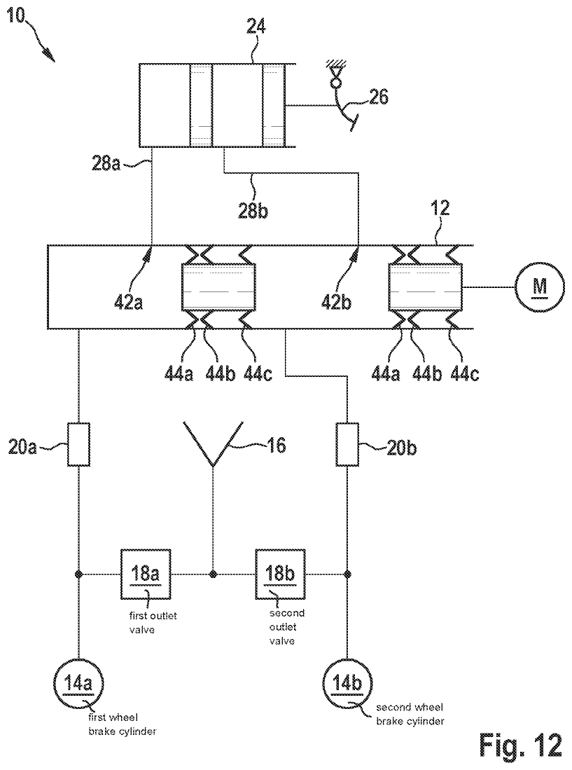

FIG. 12 shows a schematic partial representation of a twelfth embodiment of the brake system.

In the braking system of FIG. 12 as well, the master brake cylinder 24 is a tandem master brake cylinder 24, the first chamber of which is connected to the first chamber of the piston-cylinder device 12 via the first connecting line 28a and the first connecting line orifice 42a, and the second chamber of which is connected to the second chamber of the piston-cylinder device 12 via the second connecting line 28b and the second connecting line orifice 42b. Also in the brake system of FIG. 12, each connecting line orifice 42a and 42b is designed “as a sniffer bore” such that, provided the adjacent piston of the piston-cylinder device 12 is in its relevant initial position, brake fluid can be transferred from the master brake cylinder 24 into the relevant chamber of the piston-cylinder device 12, while when the adjacent piston is displaced out of its initial position, the relevant connecting line orifice 42a or 42b is sealed by means of the at least one sealing element 44a, 44b, and 44c. In addition, each piston of the piston-cylinder device 12 is equipped with the sealing elements 44a, 44b, and 44c already explained above.

With respect to further features and properties of the brake system of FIG. 12 and its advantages, reference is made to the above-explained embodiments of FIGS. 1 to 11.

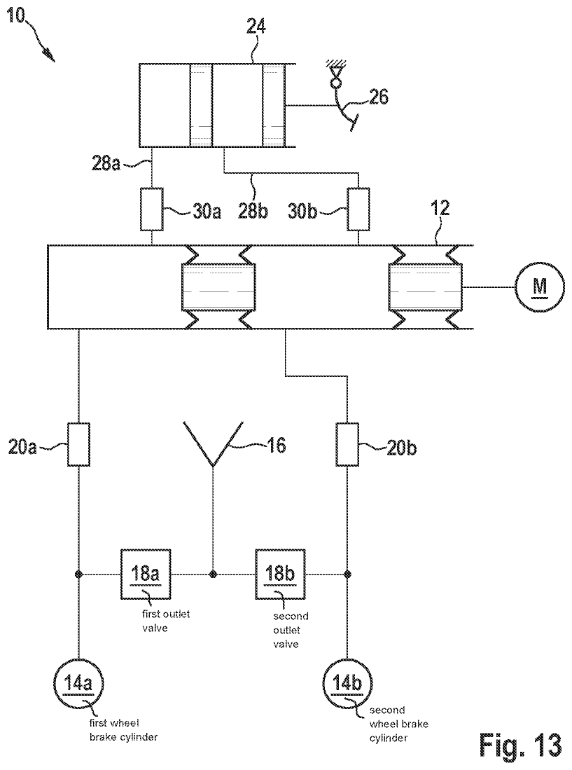

FIG. 13 shows a schematic partial representation of a thirteenth embodiment of the brake system.

Differing from the embodiment of FIG. 12, the first axle unit 10 of FIG. 13 has a master brake cylinder decoupling valve 30a or 30b in each connecting line 28a and 28b. For this reason, the first axle unit 10 of FIG. 13 can also dispense with the design of the connecting line orifices 42a and 42b “as sniffer bores” and the use of particular sealing element types.

With respect to further features and properties of the brake system of FIG. 13 and its advantages, reference is made to the above-explained embodiments of FIGS. 1 to 12.

In the embodiments of FIGS. 1, 2, 7, and 8 described above, the first axle unit has only one brake circuit which comprises at least the first wheel brake cylinder 14a, the first outlet valve 18a, the second wheel brake cylinder 14b, and the second outlet valve 18b, wherein the motorized brake pressure build-up device 12 is integrated into the brake circuit or is hydraulically connected to the brake circuit. In the embodiments of FIGS. 1, 2, 7, and 8, the first axle unit 10 is thus a single-circuit axle unit 10. In contrast, the embodiments of FIGS. 3 to 6 and 9 to 13 explained above have a first brake circuit of the first axle unit 10 with at least the first wheel brake cylinder 14a and the first outlet valve 18a and a second brake circuit of the first axle unit 10 with at least the second wheel brake cylinder 14b and the second outlet valve 18b, wherein the first brake circuit is hydraulically connected to a first chamber of the piston-cylinder device 12 and the second brake circuit is hydraulically connected to a second chamber of the piston-cylinder device 12. Optionally, the first axle unit 10 can therefore also have a two-circuit design.

Optionally, in each of the embodiments described above the first axle unit 10 may still have a control device which is designed and/or programmed to control at least the motorized brake pressure build-up device 12, the first outlet valve 18a and the second outlet valve 18b, and possibly also the at least one further valve 20a, 20b, 30, 30a, 30b, 32, 32a and 32b of the first axle unit 10, by means of at least one control signal, taking into account at least one brake command signal. The at least one brake specification signal can be output to the control device by at least one brake actuating element sensor of the vehicle, an automatic speed control system of the vehicle, a further control device of the second axle unit, and/or a further stabilization device of the brake system. The at least one brake actuating element sensor can, for example, be a rod travel sensor and/or a differential travel sensor. The automatic speed control system can, for example, be an automatic system for driverless driving of the vehicle, an adaptive cruise control, and/or an emergency brake system. The further stabilization device of the vehicle can in particular be understood to mean an ESP or an ABS control unit. The first axle unit 10 can thus cooperate with a multitude of different electronic components in order to adjust the pressure in the wheel brake cylinders 14a and 14b.

As an advantageous development, the control device can also be designed to receive and evaluate sensor signals of an upstream pressure sensor (not shown) of the first axle unit 10, at least one wheel pressure sensor (not shown) of the first axle unit 10, at least one wheel speed sensor (not shown), a yaw rate sensor and/or an acceleration sensor of at least one of the wheels of the first axle of the vehicle. Likewise, the control device can also be designed to co-control at least one motor (not shown) of the vehicle used as a generator for recuperative braking of the vehicle or to communicate advantageous information for the recuperative braking of the vehicle to the motor.

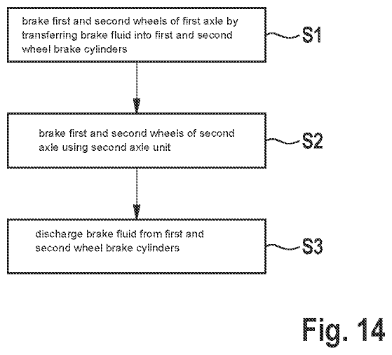

FIG. 14 shows a flowchart for explaining an embodiment of the method for braking a vehicle having at least two axles.

The method described below can, for example, be performed by means of one of the brake systems explained above. However, feasibility of the method is not limited to the use of one of these brake systems. Feasibility of the method is also not restricted to a special vehicle type/motor vehicle type of the two-axle vehicle/motor vehicle.

In a method step S1, a first wheel of a first axle of the vehicle and a second wheel of the first axle are braked by transferring, by means of operation of at least one motorized brake pressure build-up device of a first axle unit mounted on the first axle, brake fluid from a connected brake fluid reservoir into a first wheel brake cylinder assigned to the first wheel of the first axle and into a second wheel brake cylinder assigned to the second wheel of the first axle. At the same time as method step S1, a method step S2 can also be carried out in which a first wheel of a second axle of the vehicle and a second wheel of the second axle are braked by means of operation of a second axle unit which is mounted on the second axle and is designed to be hydraulically separate from the first axle unit. In addition, the method also comprises a method step S3, wherein brake fluid is discharged from the first wheel brake cylinder via a first outlet valve into the connected brake fluid reservoir and from the second wheel brake cylinder via a second outlet valve into the connected brake fluid reservoir. In this way, carrying out the method described herein also provides the advantages explained above.

1-10. (canceled)

11. A brake system for a vehicle having at least two axles, the system comprising:
a first axle unit which is configured to be mounted or is mounted on a first axle of the vehicle and has a motorized brake pressure build-up device, a first wheel brake cylinder, and a second wheel brake cylinder, wherein, by operation of the motorized brake pressure build-up device, brake fluid can be transferred from a connected first brake fluid reservoir into the first wheel brake cylinder and into the second wheel brake cylinder, so that a first wheel of the first axle assigned to the first wheel brake cylinder and a second wheel of the first axle assigned to the second wheel brake cylinder can be braked; and
a second axle unit which can be mounted or is mounted on a second axle of the vehicle and is designed to be hydraulically separate from the first axle unit, so that, by means of operation of the second axle unit, a first wheel of the second axle and a second wheel of the second axle can be braked;
wherein the first axle unit includes a first outlet valve assigned to the first wheel brake cylinder, and a second outlet valve assigned to the second wheel brake cylinder, and brake fluid can be let out of the first wheel brake cylinder via the first outlet valve and from the second wheel brake cylinder via the second outlet valve, into the connected reservoir.

12. The brake system according to claim 11, wherein a brake circuit of the first axle unit includes at least the first wheel brake cylinder, the first outlet valve, the second wheel brake cylinder, and the second outlet valve, and wherein the motorized brake pressure build-up device is integrated into the brake circuit or is hydraulically connected to the brake circuit.

13. The brake system according to claim 11, wherein a first brake circuit of the first axle unit includes at least the first wheel brake cylinder and the first outlet valve, and a second brake circuit of the first axle unit includes at least the second wheel brake cylinder and the second outlet valve, and wherein the first brake circuit is hydraulically connected to a first chamber of the motorized brake pressure build-up device configured as a piston-cylinder device, and the second brake circuit is hydraulically connected to a second chamber of the piston-cylinder device.

14. The brake system according to claim 11, wherein the first axle unit is configured to be hydraulically separate from the second axle unit in such a way that the first axle unit and the second axle unit are connected to one another at most via at least one signal line and/or bus line.

15. The brake system according to claim 11, wherein the first axle unit additionally includes a master brake cylinder to which a brake actuating element of the vehicle can be connected or is connected in such a way that at least one piston of the master brake cylinder delimiting at least one chamber of the master brake cylinder can be displaced via actuation of the brake actuating element by a driver of the vehicle, and brake fluid from the at least one chamber of the master brake cylinder can be transferred at least via at least one valveless or valve-equipped connecting line into the first wheel brake cylinder and/or into the second wheel brake cylinder.

16. The brake system according to claim 15, wherein the first outlet valve is hydraulically connected to the second outlet valve via a connecting section and the valveless or valve-equipped connecting line opens at the connecting section, and wherein a first check valve arranged in parallel with the first outlet valve is aligned in such a way that a brake fluid transfer in a direction from the first wheel brake cylinder to an orifice of the valveless or valve-equipped connecting line at the connecting section is prevented using the first check valve, and/or a second check valve arranged in parallel with the second outlet valve is aligned in such a way that a brake fluid transfer in a direction from the second wheel brake cylinder to the orifice of the valveless or valve-equipped connecting line at the connecting section is prevented using a second check valve.

17. The brake system according to claim 15, wherein the motorized brake pressure build-up device is a piston-cylinder device having at least one chamber and the master brake cylinder is hydraulically connected to the piston-cylinder device via the at least one valveless or valve-equipped connecting line such that the at least one valveless or valve-equipped connecting line in each case has a connecting line orifice on the at least one chamber of the piston-cylinder device, and wherein the at least one connecting line orifice is configured such that, if at least one displaceable piston of the piston-cylinder device is in its corresponding initial position, brake fluid can be transferred from the master brake cylinder via the at least one valveless or valve-equipped connecting line and its corresponding connecting line orifice into the at least one chamber of the piston-cylinder device, while, if the at least one displaceable piston is displaced from its corresponding initial position, a transfer of brake fluid from the master brake cylinder via the at least one valveless or valve-equipped connecting line and its corresponding connecting line orifice into the at least one chamber of the piston-cylinder device is prevented by at least one sealing element fastened to the at least one displaceable piston of the piston-cylinder device and/or in the at least one chamber of the piston-cylinder device.

18. The brake system according to claim 11, wherein the first wheel brake cylinder is hydraulically connected to the motorized brake pressure build-up device via a first isolating valve, and/or the second wheel brake cylinder is hydraulically connected to the motorized brake pressure build-up device via a second isolating valve.

19. The brake system according to claim 18, wherein a third check valve arranged in parallel with the first isolating valve is aligned in such a way that a brake fluid transfer in a direction from the first wheel brake cylinder to the motorized brake pressure build-up device is prevented using the third check valve, and/or a fourth check valve arranged in parallel with the second isolating valve is aligned in such a way that a brake fluid transfer in a direction from the second wheel brake cylinder to the motorized brake pressure build-up device is prevented using the fourth check valve.

20. A method for braking a vehicle having at least two axles, the method comprising the following steps:
braking a first wheel of a first axle of the vehicle and a second wheel of the first axle by increasing, by operation of at least one motorized brake pressure build-up device of a first axle unit mounted on the first axle, brake fluid is transferred from a connected brake fluid reservoir into a first wheel brake cylinder assigned to the first wheel of the first axle and into a second wheel brake cylinder assigned to the second wheel of the first axle; and
braking a first wheel of a second axle of the vehicle and a second wheel of the second axle by operation of a second axle unit which is mounted on the second axle and is configured to be hydraulically separate from the first axle unit;
wherein brake fluid is discharged from the first wheel brake cylinder via a first outlet valve into the connected brake fluid reservoir and from the second wheel brake cylinder via a second outlet valve, into the connected brake fluid reservoir.
